(19) United States
(12) Patent Application Publication
(10) Pub. No.: US 2003/0177334 A1
(43) Pub. Date: Sep. 18, 2003

(54) Address mapping for disk drive to accommodate multiple operating systems

(75) Inventors: Brian James King, Rochester, MN (US); Timothy Jerry Schimke, Stewartville, MN (US)

Correspondence Address: IBM Corporation, Intellectual Property Law Dept.917, 3605 Hwy. 52 North, Rochester, MN, 55901, US

(73) Assignee: International Business Machines Corporation, Armonk, NY

(21) Appl. No.: 10/097,420

(22) Filed: Mar. 14, 2002

(51) Int. Cl. G06F 12/10

(52) U.S. Cl. 711/209; 711/203; 711/210; 711/4

(57) ABSTRACT

In a first aspect and in a computer system that runs more than one operating system, a scheme for mapping memory locations in a data storage device is provided. A range of logical memory addresses at a low end of a logical memory address space is duplicated, and each duplicate range is assigned to a respective operating system, and mapped to a respective range of the storage device's physical memory address space, thereby reserving respective portions of the physical memory address space for writing of each operating system's configuration data.

### FIELD OF THE INVENTION

The present invention relates to computer systems, and more particularly to computer systems in which plural operating systems are employed.

### BACKGROUND OF THE INVENTION

FIG. 1 is a block diagram which illustrates a conventional computer system in which the present invention may be applied. Reference numeral 10 generally indicates the computer system. The computer system 10 includes a processing block 12, which may include one or more processors (not separately shown). Associated with the processing block 12 is operating system software including plural operating systems 14-1, 14-2, etc. As is well known to those who are skilled in the art, the purpose of an operating system is to control input/output and other basic operations of the processing block 12. Various application software programs may also be associated with the processing block 12, though not separately shown.

The processing block 12 is connected via a peripheral bus 16 to a storage adapter 18 and a network adapter 20. The peripheral bus 16 may be provided, for example, in accordance with the well-known PCI standard. Associated with the processing block 12 are first device drivers 22-1 and 22-2 which are respectively associated with a first operating system 14-1 and a second operating system 14-2 and are provided to manage the storage adapter 18. For each additional operating system (not separately shown) resident in the processing block 12 a respective first device driver (not separately shown) is also provided to manage the storage adapter 18. Also associated with the processing block 12 are second device drivers 24-1, 24-2, provided to manage the network adapter 20 and respectively associated with the first operating system 14-1 and the second operating system 14-2. For each additional operating system resident in the processing block a respective second device driver (not separately shown) is provided to manage the network adapter 20.

Data storage devices (e.g., disk drives) 26 are connected to the storage adapter 18 via a device bus 28. The device bus 28 may, for example, operate in accordance with the well-known SCSI standard.

In accordance with conventional practice, the storage adapter 18 translates higher level commands from the processing block 12 into lower level commands that are understood by the storage devices 26. The storage adapter 18 may also perform error recovery processing and data buffering. The storage adapter 18 may also include cache memory (not shown) in addition to cache memory (not shown) that is on board the processing block 12. Moreover, the storage adapter 18 may manage a cross drive redundancy scheme such as the conventional RAID (“redundant array of independent disks”) scheme.

The network adapter 20 may be arranged to operate in accordance with a known networking standard, such as Ethernet.

Another conventional computer system, in which the present invention may be applied, is illustrated in FIG. 1A. the computer system 10′ of FIG. 1A differs from the computer system 10 of FIG. 1, in that the stand-alone storage adapter 18 and associated storage devices 26 shown in FIG. 1 are replaced by a storage subsystem 27 connected to the peripheral bus 16 via an interface adapter such as a host bus adapter (HBA) 27a (e.g., to allow the storage subsystem 27 to be used over greater distances). The peripheral bus 16 and the HBA 27a may be connected, for example, via a storage network bus 27b such as a Fiber Channel or the like. As is familiar to those who are skilled in the art, a storage subsystem is a conventional arrangement that encompasses plural storage adapters each having storage devices (e.g., disk drives) associated therewith. A typical storage subsystem is illustrated in block diagram form in FIG. 1B. Referring to FIG. 1B, the storage subsystem 27 includes a processing complex 29, to which plural storage adapters 18 are connected. A respective plurality of storage devices 26 are connected to each storage adapter 18. Also connected to the processing complex 29 are port adapters 31, which allow the storage subsystem 27 to be interfaced to a plurality of host systems simultaneously (although the storage subsystem is shown attached to only one host in FIG. 1A). The processing complex 29, as is well known, provides translation, mapping and processing (e.g., caching) functions. The storage subsystem 27 shown in FIG. 1A may, for example, be the Enterprise Storage Server available from International Business Machines Corporation, the assignee hereof.

As illustrated by the computer systems of FIGS. 1 and 1A, there is a trend toward running plural operating systems concurrently in computer systems. In such cases, individual data storage devices 26 are assigned to each of the operating systems. Alternatively one or more of the data storage devices 26 may be partitioned among two or more of the operating systems.

According to known practices, each operating system writes configuration data into the data storage devices that are assigned to it. Typically, the configuration data stored by an operating system in a storage device includes an identifier or token which is used to uniquely identify the storage device. The identifier can be used by the operating system to keep track of storage devices that are assigned to it, and to distinguish such storage devices from each other.

Usually operating system configuration data is written at or near the beginning of the address space of a storage device. However, there is no standard location in which configuration data is written, and the locations for writing configuration data accordingly vary from operating system to operating system.

One concern that arises with computer systems running multiple operating systems is corruption of data when a storage device is being transferred from one operating system to another. When the transfer is intentional and planned, data corruption can generally be avoided by suitably disposing of data that belongs to the releasing operating system. However, in the case of an operator error, in which a storage device is transferred briefly from one operating system to another and then back to the first operating system, the present inventors have recognized that writing of configuration data to the storage device by the second operating system may corrupt user data that was written to the storage device by the first operating system.

### SUMMARY OF THE INVENTION

According to the invention, a method of managing a storage device is provided in a computer system that is operable with a plurality of operating systems. The plurality of operating systems includes at least a first operating system and a second operating system. The computer system includes a storage device that has a range of physical memory addresses. The method includes associating with the first operating system a first mapping of logical memory addresses to physical memory addresses of the storage device and associating with the second operating system a second mapping of logical memory addresses to physical memory addresses of the storage device. The second mapping is different from the first mapping.

In at least one aspect of the invention, the physical memory addresses to which the first mapping maps logical memory addresses may overlap with the physical memory addresses to which the second mapping maps logical memory addresses. The first and second mappings may indicate to the respective operating systems a range of logical memory addresses that is less than the range of physical memory addresses of the storage device.

Further in at least one aspect of the invention, the associating steps of the method may be performed by a storage adapter connected to the storage device. Alternatively, the associating steps may be performed by the storage device. As still another alternative, the associating steps may be performed by device driver software that operates with the operating systems to control the storage device. Furthermore the associating steps may be performed by a storage subsystem that includes the storage device.

According to another aspect of the invention, a method of managing a storage device is provided in a computer system that maps logical addresses to physical addresses of the storage device. The method includes establishing duplicate ranges of logical memory addresses, and mapping each of the duplicate ranges of logical memory addresses to a respective range of the physical memory addresses of the storage device.

The method according to this aspect of the invention may further include assigning each of the duplicate ranges of logical memory addressees to a respective one of a plurality of operating systems when the computer system is operable with plural operating systems. The method may further include storing configuration data for a respective one of the operating systems in each of the duplicate ranges of logical memory addresses.

With the present invention, respective physical memory address ranges are reserved for the configuration data of each operating system. In this way, corruption of user data of one operating system by writing of configuration data of another operating system can be prevented. Moreover, the remapping of the physical address space to accommodate the reserved sections for each operating system is transparent to the operating systems, so that no modification of the operating systems is necessary. The reserved sections of physical memory may be small relative to the storage capacity of the storage device, so that only a small loss of storage is incurred.

The above methods may be implemented in a computer system that includes a processing block including one or more processors, a storage adapter connected to the processing block, and a storage device connected to the storage adapter. The storage adapter and the storage device may be part of a storage subsystem that is connected to the processing block. Numerous other aspects are provided, as are computer program products. Each inventive computer program product may be carried by a medium readable by a computer (e.g., a carrier wave signal, a floppy disk, a hard drive, a random access memory, etc.).

Other objects, features and advantages of the present invention will become more fully apparent from the following detailed description of exemplary embodiments, the appended claims and the accompanying drawings.

### BRIEF DESCRIPTION OF THE DRAWINGS

FIG. 1 is a block diagram representation of a conventional computer system in which the present invention may be applied;

FIG. 1A is a block diagram representation of another conventional computer system in which the present invention may be applied;

FIG. 1B is a block diagram representation of a storage subsystem that is included in the computer system of FIG. 1A;

FIG. 2 schematically illustrates a conventional mapping of logical memory addresses to physical memory addresses of a storage device such as a disk drive;

FIG. 3 schematically illustrates a mapping of logical memory addresses to physical memory addresses of a storage device in accordance with the invention; and

FIG. 4 is a flow chart that illustrates a method provided in accordance with the invention in regard to the memory mapping of FIG. 3.

### DETAILED DESCRIPTION

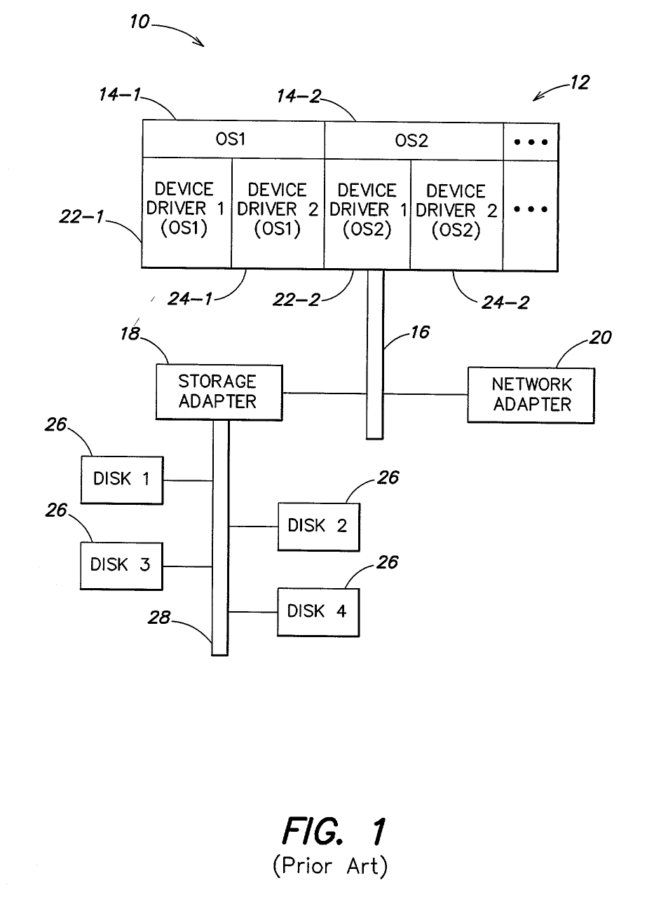

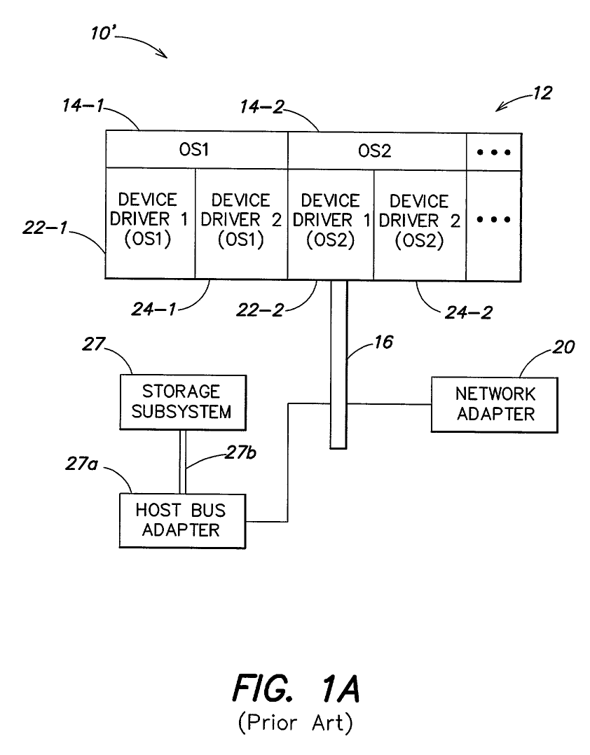

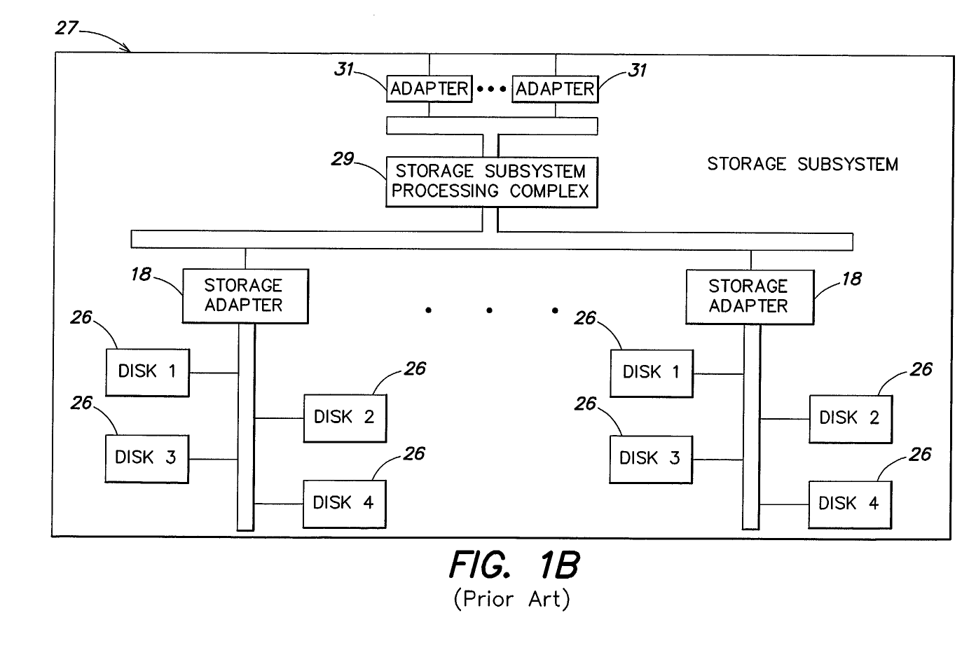

In accordance with the present invention, a respective range of physical memory addresses in a data storage device is reserved for each operating system of a plurality of operating systems that may run concurrently or sequentially in a computer system like the computer system of FIGS. 1 or 1A. Each of the reserved ranges of the physical memory space of the storage device is mapped to a “low end” range of the logical memory space of the storage device so that when an operating system writes configuration data into the beginning portion of the logical memory space, the configuration data is automatically stored in the reserved physical memory range for the operating system in question. Different mappings of logical memory addresses to physical memory addresses are provided for each operating system. The translation of logical memory addresses to physical memory addresses, and the associated address mappings and assignments of physical memory addresses to respective operating systems, may be carried out at the level of the storage subsystem 27, storage adapter 18, the storage device 26, or the device driver 22.

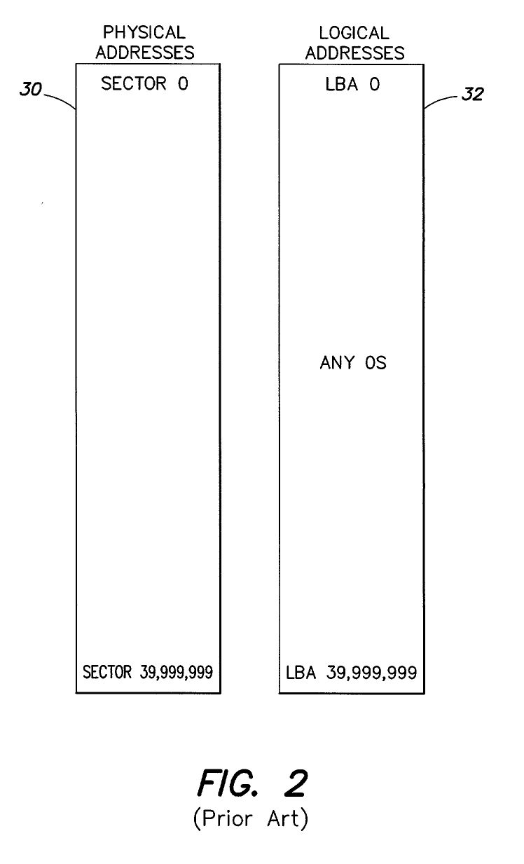

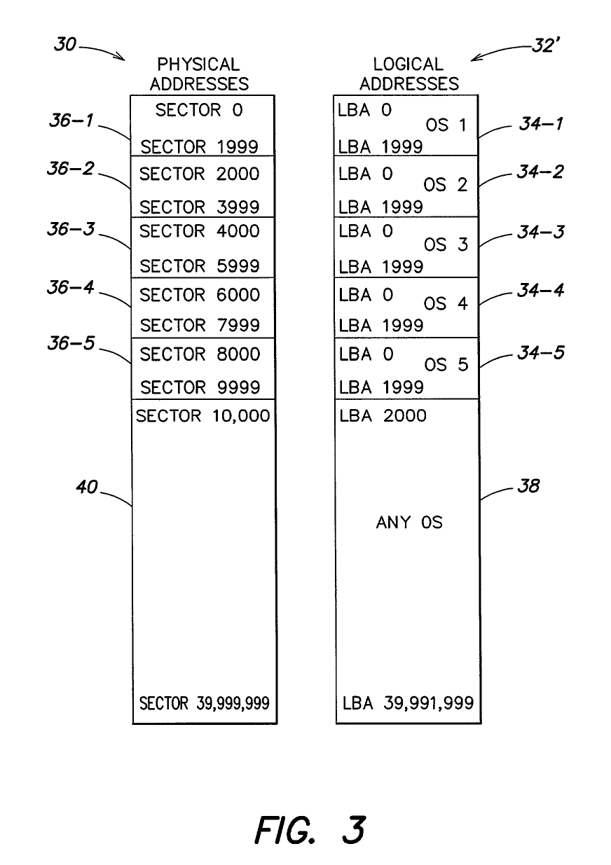

The present invention may be more clearly understood by reference to an example of a memory map provided in accordance-with the invention and explained in connection with FIGS. 2 and 3.

FIG. 2 presents, for purposes of comparison, a conventional mapping of logical memory addresses to physical memory addresses for a storage device (not shown). For the purposes of this example, it is assumed that the storage device has 40 million sectors or address blocks, having a capacity of 512 bytes per block, thus corresponding to a total storage capacity of about 20 gigabytes. Other data storage sizes may be employed.

The physical memory space of the storage device is represented by box 30 at the left hand side of FIG. 2. The physical memory address space 30 consists of sectors 0 through 39,999,999. The logical memory address space is represented by box 32 at the right hand side of FIG. 2. The corresponding logical memory address space consists of 40 million logical block addresses (LBA's), corresponding to LBA's 0 through 39,999,999. Each LBA is mapped to a corresponding physical memory address (sector), i.e. to a physical memory address having the same number designation as the LBA. Thus LBA's 0 through 39,999,999 are mapped into sectors 0 through 39,999,999, respectively. This mapping of logical memory addresses to physical memory addresses is used for any operating system OS to which the data storage device is assigned.

An example of a mapping of logical memory addresses to physical memory addresses in accordance with the invention is illustrated in FIG. 3. The physical memory address space of the storage device, represented again by box 30 in FIG. 3, still consists of 40 million physical memory addresses or sectors, namely sectors 0 through 39,999,999. However, the logical memory address space in accordance with the invention, as represented by box 32′ in FIG. 3, is different from the conventional logical memory address space 32 of FIG. 2. In the inventive logical memory address space 32′ of FIG. 3, lower end ranges of the logical memory address space are duplicated and each duplicate range is assigned to a respective operating system. In the particular example of FIG. 3, the duplicate memory address ranges consist of two thousand LBA's apiece and are represented by boxes 34-1 through 34-5. Thus a first duplicate range 34-1 corresponds to LBA's 0 through 1,999 of the logical memory address space for a first operating system (OS1), and is mapped into a range 36-1 of the physical memory address space 30, corresponding to sectors 0 through 1,999.

A second duplicate range 34-2, corresponding to LBA's 0 through 1,999 of the logical memory address space for a second operating system (OS2), is mapped into a second range 36-2 of the physical memory address space 30, corresponding to sectors 2,000 through 3,999.

A third duplicate range 34-3, corresponding to LBA's 0 through 1,999 of the logical memory address space for a third operating system (OS3), is mapped into a third range 36-3 of the physical memory address space 30, corresponding to sectors 4,000 through 5,999.

A fourth duplicate range 34-4, corresponding to LBA's 0 through 1,999 of the logical memory address space for a fourth operating system (OS4), is mapped into a fourth range 36-4 of the physical memory address space 30, corresponding to sectors 6,000 through 7,999.

A fifth duplicate range 34-4, corresponding to LBA's 0 through 1,999 of a logical memory address space for a fifth operating system (OS5), is mapped into a fifth range 36-5 of the physical memory address space 30, corresponding to sectors 8,000 through 9,999.

Thus, the range of LBA's 0 through 1,999 is duplicated five times in this exemplary inventive mapping and each of the duplicate ranges is assigned to a respective operating system and mapped into a respective physical memory address range of 2,000 sectors.

For each of the five operating systems, the balance of the logical memory address space corresponds to LBA's 2,000 through 39,991,999 (represented by box 38) and is mapped into the balance of the physical memory address space 30, represented by box 40, and corresponding to sectors 10,000 through 39,999,999.

Consequently, for the first operating system (OS1), the logical memory address space 32′ consists of LBA's 0 through 39,991,999 and is mapped into sectors 0 through 1,999 followed by sectors 10,000 through 39,999,999 of the physical memory space 30. For the second operating system (OS2), the logical memory address space 32′ again consists of LBA's 0 through 39,991,999, but is mapped into sectors 2,000 through 3,999 followed by sectors 10,000 through 39,999,999 of the physical memory space 30. The logical memory address space 32′ for the third operating system (OS3), again consisting of LBA's 0 through 39,991,999, is mapped into sectors 4,000 through 5,999 followed by sectors 10,000 through 39,999,999 of the physical memory space 30. The logical memory address space 32′ for the fourth operating system (OS4) consists of LBA's 0 through 39,991,999 and is mapped into sectors 6,000 through 7,999 followed by sectors 10,000 through 39,999,999 of the physical memory space 30. Finally, the logical memory address space 32′ for the fifth operating system (OS5) consists of LBA's 0 through 39,991,999 and is mapped into sectors 8,000 through 39,999,999 of the physical memory space 30.

From the point of view of the physical memory address space 30, the range 36-1, corresponding to sectors 0 through 1,999, is reserved for the first operating system (OS1); the range 36-2, corresponding to sectors 2,000 through 3,999, is reserved for the second operating system (OS2); the range 36-3, corresponding to sectors 4,000 through 5,999, is reserved for the third operating system (OS3); the range 36-4, corresponding to sectors 6,000 through 7,999, is reserved for the fourth operating system (OS4); and the range 36-5, corresponding to sectors 8,000 through 9,999, is reserved for the fifth operating system (OS5). The configuration data for the operating systems OS1-OS5 will be written into the respective reserved ranges 36-1 through 36-5, and consequently cannot corrupt the user data of any other operating system.

As to each operating system OS1-OS5, the apparent reduction in storage capacity of the storage device is 8,000 sectors, which is much less than one-tenth of one percent of the total storage capacity of the storage device (e.g., in the present example in which the storage device employs 40 million sectors). To generalize the quantitive relationship between logical and physical memory spaces in accordance with the invention, assume n(>1) operating systems are involved, that the range of physical memory addresses of the storage device (total storage capacity) consists of Nₚ physical memory addresses. Further assume that i physical memory addresses are reserved for each operating system. Then, if N₁ is the number of logical memory addresses available for each OS,

N₁=Nₚ−((n−1)×i).

Meanwhile, the amount of memory space reserved for each operating system OS1-OS5, into which configuration data and other data may be stored, is about one megabyte in the example illustrated in FIG. 3, which is likely to be more than adequate. The amount of reserved memory space for each operating system OS1-OS5 may, of course, be more or less than the 2,000 sectors of 512 bytes apiece as provided in the example of FIG. 3. The actual amount of memory space reserved for each operating system may be selected to be the maximum quantity required for any one of the operating systems to be used with the computer system in question. Alternatively, the amount of memory space reserved for each operating system may be greater than the maximum required by any one of the operating systems, to allow for growth and expansion of operating systems in the future.

In the example shown in FIG. 3, the same amount of memory space is reserved for each operating system OS1-OS5. However, this is not required, and the amount of memory space reserved for each operating system may be tailored to the needs of the respective operating system.

In the example shown in FIG. 3, reserved memory space is provided for five operating systems. However, it should be understood that the number of operating systems accommodated in a particular example of the inventive memory mapping scheme is at least two but may be more or less than five. It will equally be appreciated that the inventive memory mapping scheme is applicable to storage devices having a greater or smaller capacity than 20 gigabytes.

It may be advisable to accommodate a number of operating systems that is greater than the number of operating systems initially intended to be run on the computer system to allow for expansion in the future in the number of operating systems to be run on the computer system.

Assuming that the inventive memory mapping scheme is carried out at the storage adapter 18 (FIG. 1), an operating system that is to perform memory access operations with respect to a particular storage device 26 is suitably identified to the storage adapter 18 so that the storage adapter 18 can use the proper memory mapping for the operating system in question. The identification of the operating system in question may be provided by a command from the device driver corresponding to the storage adapter, or, alternatively, may occur by another mechanism, such as writing the identifying data for the operating system in a register in the storage adapter 18.

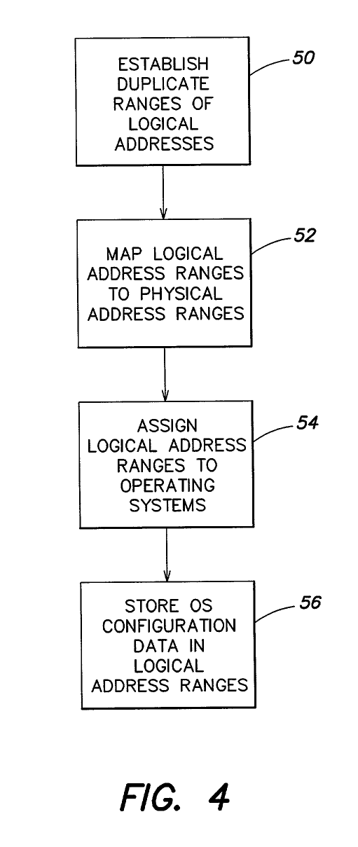

FIG. 4 is a block diagram which illustrates a process involved in the inventive memory mapping scheme of FIG. 3. The process of FIG. 4 begins with a block 50, at which duplicate ranges of logical addresses are established. The duplicate logical address ranges correspond to the ranges 34-1 through 34-5 illustrated in FIG. 3. As noted above, this function (and the other functions to be described in connection with FIG. 4) may be performed at the level of a storage adapter, a storage device, or a storage subsystem. These functions may also be performed at the device driver level, by coordination among the various device drivers corresponding to the different operating systems being employed.

Following block 50 is block 52. At block 52, the duplicate logical address ranges are each mapped into a respective physical memory address range. The physical memory address ranges into which the duplicate logical memory address ranges are mapped are represented, in FIG. 3, by ranges 36-1 through 36-5.

Next following block 52 is block 54. At block 54, each of the duplicate logical memory address ranges is assigned to a respective operating system. This assignment has the effect of reserving the corresponding physical memory address ranges to the respective operating systems. Then, at block 56, which may be performed at various times after the other blocks, the operating systems (e.g., OS1-OS5 in FIG. 3) store configuration data in the duplicate logical memory address ranges (e.g., ranges 34-1 through 34-5 in FIG. 3) which have been assigned thereto, thereby effectively storing the configuration data in the corresponding reserved physical memory address ranges (e.g., ranges 36-1 through 36-5 in FIG. 3).

With the memory mapping scheme of the present invention, a storage device can be moved between different operating systems without causing data corruption, and each operating system can write its configuration data in the storage device. No changes are required to the operating systems, and it is unnecessary for the operating systems to be in agreement on a common device layout or to conform to a standard in terms of where configuration data is stored. Multiple operating systems can have their respective configuration data stored concurrently on the storage device. The loss of storage capacity for the storage device is minimal.

The process of FIG. 4 may comprise one or more computer program products and/or may comprise software of a storage adapter, storage device, device driver or storage subsystem. Each inventive computer program product may be carried by a medium readable by a computer (e.g., a carrier wave signal, a floppy disk, a hard drive, a random access memory, etc.).

The foregoing description discloses only exemplary embodiments of the invention; modifications of the above-disclosed apparatus and methods which fall within the scope of the invention will be readily apparent to those of ordinary skill in the art. For example, the present invention may be applied to accommodate plural types of operating systems, or plural instances of the same type of operating system, or a combination of both.

It is also contemplated that no reserved portion of the storage device may be provided for an operating system which is of a type that does not write configuration data to storage devices.

In one or more embodiments, the present invention may be configured to transparently process operations spanning remapped boundaries of a storage device (e.g., physical memory ranges 36-1 through 36-5 in FIG. 3). For example, if the present invention is practiced via the storage adapter 18 (FIG. 1), the storage adapter 18 may internally split a read or write operation received from (requested by) an operating system if the read or write operation spans remapped boundaries of a storage device. After the read or write operation is complete, the storage adapter 18 may generate a single response to the requesting operating system. In this manner, neither the requesting operating system nor the respective device driver will be aware of or dependent on remapped boundaries of the storage device. Similar operations may be performed at the device driver, storage device or storage subsystem level.

In at least one embodiment, an identifier may be sent from the device driver software 22 to the storage adapter 18 to identify an operating system (e.g., the type of operating system) before the operating system reads from or writes to a storage device 26 associated with the storage adapter 18. In this manner, the storage adapter 18 may determine the correct mapping to employ for read or write operations which fall within the remapped region of the storage device. Other mechanisms for notifying the storage adapter 18 of operating system type may be employed, such as writing to one or more registers (not shown) of the storage adapter 18. If the present invention is implemented at the device driver level (e.g., within the device driver software for each operating system), the storage adapter 18 need not be informed of operating system type.

In an embodiment of the invention wherein multiple instances of the same type of operating system are employed, an operating system type or operating system instance number may be passed to the storage adapter 18 from the device driver software 22 (e.g., to reduce potential corruption associated with moving the storage adapter 18 or a storage device associated therewith between multiple copies of the same operating system). Alternatively, each operating system may employ multiple operating system type values instead of a single value to allow multiple copies of the same operating system to be distinguished (e.g., by assigning each copy of the same operating system a different type value).

The device driver software 22 and/or the storage adapter 18 may be notified when a storage device becomes associated with only one operating system (e.g., if the storage device becomes “owned” by the operating system). For example, the device driver software 22 may send a command to the storage adapter 18 informing the storage adapter 18 of the change. Alternatively, the storage adapter 18 may be configured to recognize that a command (e.g., a Format command) currently being processed will affect changes to an entire storage device 26, and that it is now safe to clear other remapped portions of the storage device 26. In response thereto, the device driver software 22 and/or the storage adapter 18 may clear residual configuration information, user information, etc., stored in remapped portions of the storage device for other operating systems (e.g., to reduce confusion if the storage device becomes associated with one or more other operating systems).

Accordingly, while the present invention has been disclosed in connection with exemplary embodiments thereof, it should be understood that other embodiments may fall within the spirit and scope of the invention, as defined by the following claims.

The invention claimed is:

1. In a computer system operable with a plurality of different types of operating systems, including at least a first operating system and a second operating system, the computer system including a storage device that has a range of physical memory addresses, a method of managing the storage device, the method comprising:
associating with the first operating system a first mapping of logical memory addresses to physical memory addresses of the storage device; and
associating with the second operating system a second mapping of logical memory addresses to physical memory addresses of the storage device, the second mapping being different from the first mapping, in that the physical memory addresses to which the first mapping maps logical memory addresses partially overlap with the physical memory addresses to which the second mapping maps logical memory addresses.

2. The method of claim 1, wherein the plurality of operating systems consists of n operating systems (n>1), the range of physical memory addresses consists of Nₚ physical memory addresses, the mappings each reserve i physical memory addresses for each operating system, and a number N₁ of logical memory addresses in each mapping is in accordance with the following formula:
N₁=Nₚ−((n−1)×i).

3. The method of claim 1, wherein the first and second mappings indicate to the respective operating systems a range of logical memory addresses that is less than the range of physical memory addresses of the storage device.

4. The method of claim 1, wherein the associating steps are performed by a storage subsystem that includes the storage device.

5. The method of claim 1, wherein the associating steps are performed by a storage adapter connected to the storage device.

6. The method of claim 1, wherein the associating steps are performed by the storage device.

7. The method of claim 1, wherein the associating steps are performed by device driver software that operates with the operating systems to control the storage device.

8. The method of claim 1, wherein the storage device is a disk drive, and the physical memory addresses correspond to sectors on the disk drive.

9. The method of claim 1, wherein the first
operating system is a first instance of a first type of operating system, and the second operating system is a second instance of the first type of operating system.

10. A computer system, comprising a processing block, including one or more processors, the processing block being operable with a plurality of different types of operating systems including at least a first operating system and a second operating system;
a storage adapter connected to the processing block;
a storage device connected to the storage adapter and having a range of physical memory addresses;
means for associating with the first operating system a first mapping of logical memory addresses to physical memory addresses of the storage device; and
means for associating with the second operating system a second mapping of logical memory addresses to physical memory addresses of the storage device, the second mapping being different from the first mapping, in that the physical memory addresses to which the first mapping maps logical memory addresses partially overlap with the physical memory addresses to which the second mapping maps logical memory addresses.

11. The computer system of claim 10, wherein the plurality of operating systems consists of n operating systems (n>1), the range of physical memory addresses consists of Nₚ physical memory addresses, the mappings each reserve i physical memory addresses for each operating system, and a number N₁ of logical memory addresses in each mapping is in accordance with the following formula:
N₁=Nₚ−((n−1)×i).

12. The computer system of claim 10, wherein the first and second mappings indicate to the respective operating systems a range of logical memory addresses that is less than the range of physical memory addresses of the storage device.

13. The computer system of claim 10, wherein the means for associating are included in the storage adapter.

14. The computer system of claim 10, wherein the means for associating are included in the storage device.

15. The computer system of claim 10, wherein the storage device and the storage adapter are part of a storage subsystem connected to the processing block.

16. The computer system of claim 15, wherein the means for associating are included in the storage subsystem.

17. The computer system of claim 10, wherein the means for associating include device driver software that operates with the operating systems to control the storage device.

18. The computer system of claim 10, wherein the storage device is a disk drive, and the physical memory addresses correspond to sectors on the disk drive.

19. The computer system of claim 10, wherein the first operating system is a first instance of a first type of operating system, and the second operating system is a second instance of the first type of operating system.

20. A computer program product for managing a storage device, comprising:
a medium readable by a computer, the computer readable medium having computer program code adapted to:
associate with a first operating system a first mapping of logical memory addresses to physical memory addresses of the storage device; and
associate with a second operating system a second mapping of logical memory addresses to physical memory addresses of the storage device, the second mapping being different from the first mapping, in that the physical memory addresses to which the first mapping maps logical memory addresses partially overlap with the physical memory addresses to which the second mapping maps logical memory addresses.

21. In a computer system that maps logical memory addresses to physical memory addresses of a storage device, a method of managing the storage device, the method comprising:
establishing duplicate ranges of logical memory addresses; and
mapping each of the duplicate ranges of logical memory addresses to a respective range of the physical memory addresses of the storage device.

22. The method of claim 21, wherein the computer system is operable with a plurality of operating systems and further comprising the step of assigning each of the duplicate ranges of logical memory addresses to a respective one of the operating systems.

23. The method of claim 22, further comprising
the step of storing configuration data for a respective one of the operating systems in each of the duplicate ranges of logical memory addresses.

24. The method of claim 23, wherein each of the duplicate ranges of logical memory addresses corresponds to a lower end of a logical memory address space.

25. The method of claim 21, wherein the establishing and mapping steps are performed by a storage subsystem that includes the storage device.

26. The method of claim 21, wherein the establishing and mapping steps are performed by a storage adapter connected to the storage device.

27. The method of claim 21, wherein the establishing and mapping steps are performed by the storage device.

28. The method of claim 21, wherein the establishing and mapping steps are performed by device driver software that operates with respective operating systems to control the storage device.

29. The method of claim 21, wherein the storage device is a disk drive, and the physical memory addresses correspond to sectors on the disk drive.

30. The method of claim 21, wherein the respective ranges of physical memory addresses collectively include less than 1% of a storage capacity of the storage device.

31. A computer system, comprising:
a processing block, including one or more processors;
a storage adapter connected to the processing block;
a storage device connected to the storage adapter;
means for establishing duplicate ranges of logical memory addresses; and
means for mapping each of the duplicate ranges of logical memory addresses to a respective range of physical memory addresses of the storage device.

32. The computer system of claim 31, wherein the processing block is operable with a plurality of operating systems, and further comprising means for assigning each of the duplicate ranges of logical memory addresses to a respective one of the operating systems.

33. The computer system of claim 32, further comprising means for storing configuration data for a respective one of the operating systems in each of the duplicate ranges of logical memory addresses.

34. The computer system of claim 33, wherein each of the duplicate ranges of logical memory addresses corresponds to a lower end of a logical memory address space.

35. The computer system of claim 31, wherein the means for establishing and the means for mapping are included in the storage adapter.

36. The computer system of claim 31, wherein the means for establishing and the means for mapping are included in the storage device.

37. The computer system of claim 31, wherein the storage device and the storage adapter are part of a storage subsystem connected to the processing block.

38. The computer system of claim 37, wherein the means for establishing and the means for mapping are included in the storage subsystem.

39. The computer system of claim 31, wherein the means for establishing and the means for mapping include device driver software that operates with plural operating systems to control the storage device.

40. The computer system of claim 31, wherein the storage device is a disk drive, and the physical memory addresses correspond to sectors on the disk drive.

41. The computer system of claim 31, wherein the respective ranges of physical addresses collectively include less than 1% of a storage capacity of the storage device.

42. A computer program product for managing a storage device, comprising:
a medium readable by a computer, the computer readable medium having computer program code adapted to:
establish duplicate ranges of logical memory addresses; and
map each of the duplicate ranges of logical memory addresses to a respective range of physical memory addresses of the storage device.
